(19) United States
(12) Patent Application Publication
(10) Pub. No.: US 2015/0202562 A1
(43) Pub. Date: Jul. 23, 2015

(54) SORBENT ARTICLE

(71) Applicant: Multisorb Technologies, Inc., Buffalo, NY (US)

(72) Inventors: Samuel A. Incorvia, North Tonawanda, NY (US); Kenneth Credle, Winter Park, FL (US); Stanislav E. Solovyov, Getzville, NY (US)

(21) Appl. No.: 14/674,703

(22) Filed: Mar. 31, 2015

Related U.S. Application Data
(63) Continuation of application No. PCT/US2013/062907, filed on Oct. 1, 2013.
(60) Provisional application No. 61/708,414, filed on Oct. 1, 2012.

(51) Int. Cl. B01D 53/04; B01J 20/26; B01J 20/28; B01D 53/26

(52) U.S. Cl. CPC B01D 53/0407; B01D 53/261; B01J 20/26; B01J 20/28042; B01J 20/28057; B01D 2253/34; B01D 2253/25; B01D 2257/80; B01D 2259/45

(57) ABSTRACT

A sorbent article formed from a resin bonded sorbent composition and having a first volume of the resin bonded sorbent composition used to form the sorbent article and a first surface area equal to a first total area of exposed surfaces of the first volume, the sorbent article including a base having an exposed surface area including only flat surfaces, convex surfaces or combinations thereof, at least one of: a protrusion extending from the exposed surface area of the base; and/or, a partial bore extending into the exposed surface area of the base, a capacity ratio of the first volume to a second volume greater than or equal to 0.5 and an uptake rate ratio greater than or equal to 2.0, wherein the uptake rate ratio is calculated according to the equation:

$$α = \frac{{SA}_{1} / {V}_{1}}{{SA}_{2} / {V}_{2}} ,$$

wherein: α is the uptake rate ratio, SA₁ is the first surface area, V₁ is the first volume, SA₂ is a second surface area and V₂ is the second volume. A comparative sorbent article comprises the second volume and the second surface area, the second volume comprising only flat surfaces, convex surfaces or combinations thereof and being a minimum volume necessary to inscribe the first volume and the second surface area equal to a second total area of exposed surfaces of the second volume.

### CROSS-REFERENCE TO RELATED APPLICATIONS

This patent application is a Continuation of International Patent Application Serial No. PCT/US2013/062907, filed on Oct. 1, 2013, which patent application claims the benefit under 35 U.S.C. §119(e) and Article 4 of the Stockholm Act of the Paris Convention for the Protection of Industrial Property of U.S. Provisional Patent Application No. 61/708,414, filed Oct. 1, 2012, which applications are incorporated herein by reference.

### TECHNICAL FIELD

The present invention relates generally to articles comprising sorbents, and more particularly, to improved articles of manufacture fabricated from sorbents in a resinous base.

### BACKGROUND

Incorporation of sorbents, e.g., desiccants, into resin matrices has been revealed in several contexts. Formation of these resins into structural or functional shapes by various processes has been described in certain applications. Similarly, fillers have been added to structural molding resins. Low cost mineral or other fillers have been added to resin-containing compositions to extend the resin and reduce costs, while maintaining strength sufficient for the intended end-use application of the molded article. It is also a frequent practice to add reinforcing materials, such as glass fibers or beads to enhance mechanical properties of molding resins, e.g., hardness, tensile displacement, and so on. With reinforcing additives, just as with fillers, it has been found there are ranges within which the desired effects of extending the resin or reinforcing the molded article are accomplished while maintaining satisfactory injection molding and mechanical properties.

Nevertheless, molding compositions comprising reinforcing additives have not been entirely satisfactory for a number of end-use applications. For example, a molding composition having relatively high loading levels of reinforcing additives, such as glass fibers and glass beads, have the effect of limiting the loading factor of sorbent additives which may be introduced into such molding compositions for optimal adsorption or absorption performance. However, with a corresponding reduction in the loading of reinforcing additives and an increase in the loading of sorbent additives, there is also a potential for a reduction in desirable mechanical properties, such as hardness, tensile strength, and other mechanical properties.

Thus, existing resin/sorbent matrices suffer from several drawbacks. The materials are often brittle and insufficient to survive standard drop testing. Additionally, particulate material may be released from the matrices thereby degrading part performance and/or device functionality. Due to the structure of these matrices, water may be adsorbed or absorbed at a faster rate, which in fact may be too fast for common manufacturing procedures. In other words, the ability for a part to adsorb or absorb water may be exhausted prior to its assembly in a device because environmental conditions are not controlled in the manufacturing area. Existing resin/sorbent matrices are often quite expensive to manufacture and use due to the use of exotic resin, additional processing steps and the use of multi-resin materials having phase boundaries. Additionally, existing resin/sorbent matrices may pose compatibility issues due to materials typically used as binders.

Further complications arise from varying needs in different applications. For example, a single application may require rapid uptake of a fluid such as water at the onset followed by continued long term uptake of the fluid at a slower rate. Heretofore, a single solution to the foregoing problem had not been found.

Accordingly, there is a need for an improved sorbent article, and more particularly, articles of manufacture formed from a resin bonded sorbent and comprising a first portion configured for rapid uptake of a fluid and a second portion for slower uptake of the fluid.

### SUMMARY

It is therefore a principal object of the invention to provide an article of manufacture configured for both rapid and slow uptake of a fluid.

The present invention broadly comprises a sorbent article formed from a resin bonded sorbent composition and having a first volume of the resin bonded sorbent composition used to form the sorbent article and a first surface area equal to a first total area of exposed surfaces of the first volume, the sorbent article including a base having an exposed surface area including only flat surfaces, convex surfaces or combinations thereof, at least one of: a protrusion extending from the exposed surface area of the base; and/or, a partial bore extending into the exposed surface area of the base, a capacity ratio of the first volume to a second volume greater than or equal to 0.5 and an uptake rate ratio greater than or equal to 2.0, wherein the uptake rate ratio is calculated according to the equation:

$$α = \frac{{SA}_{1} / {V}_{1}}{{SA}_{2} / {V}_{2}} ,$$

wherein: α is the uptake rate ratio, SA₁ is the first surface area, V₁ is the first volume, SA₂ is a second surface area and V₂ is the second volume. A comparative sorbent article includes the second volume and the second surface area, the second volume including only flat surfaces, convex surfaces or combinations thereof and being a minimum volume necessary to inscribe the first volume and the second surface area equal to a second total area of exposed surfaces of the second volume. In some embodiments, the second volume is a three dimensional shape selected from the group consisting of: a convex regular polyhedron, a prism, a cylinder, a sphere, an ellipsoid, a cone, and a pyramid.

In some embodiments, the sorbent article further includes a cylindrical base and at least one protrusion extending from the cylindrical base. In some embodiments, the sorbent article further includes a sidewall extending generally perpendicularly from a circumferential edge of the cylindrical base. In some embodiments, the at least one protrusion tapers from a first end to a second end proximate the cylindrical base. In some embodiments, the sorbent article further includes a cylindrical body includes at least one partial bore extending into the exposed surface area of the base. In some embodiments, the at least one partial bore includes a cross sectional shape selected from the group consisting of: a circle, a polygon, and a star. In some embodiments, the at least one partial bore tapers from a first end to a second end.

In some embodiments, the uptake rate ratio is greater than or equal to 3.0. In some embodiments, the uptake rate ratio is greater than or equal to 4.0. In some embodiments, the uptake rate ratio is greater than or equal to 5.0.

The present invention broadly comprises a sorbent article formed from a resin bonded sorbent composition and having a first volume of the resin bonded sorbent composition used to form the sorbent article and a first surface area equal to a first total area of exposed surfaces of the first volume, the sorbent article including a base, at least one of: a protrusion extending from the base; a through bore within the base; and/or, a partial bore within the base, a capacity ratio of the first volume to a second volume greater than or equal to 0.5 and an uptake rate ratio greater than or equal to 2.0, wherein the uptake rate ratio is calculated according to the equation:

$$α = \frac{{SA}_{1} / {V}_{1}}{{SA}_{2} / {V}_{2}} ,$$

wherein: α is the uptake rate ratio, SA₁ is the first surface area, V₁ is the first volume, SA₂ is a second surface area and V₂ is the second volume. A comparative sorbent article includes the second volume and the second surface area, the second volume including only flat surfaces, convex surfaces or combinations thereof and being a minimum volume necessary to inscribe the first volume and the second surface area equal to a second total area of exposed surfaces of the second volume. In some embodiments, the second volume is a three dimensional shape selected from the group consisting of: a convex regular polyhedron, a prism, a cylinder, a sphere, an ellipsoid, a cone, and a pyramid.

In some embodiments, the sorbent article further includes a cylindrical base and at least one protrusion extending from the cylindrical base. In some embodiments, the sorbent article further includes a sidewall extending generally perpendicularly from a circumferential edge of the cylindrical base. In some embodiments, the at least one protrusion tapers from a first end to a second end proximate the cylindrical base. In some embodiments, the sorbent article further includes a cylindrical body includes at least bore extending into the cylindrical base. In some embodiments, the at least one bore is at least one through bore and includes a cross sectional shape selected from the group consisting of: a circle, a polygon, and a star. In some embodiments, the at least one bore tapers from a first end to a second end.

In some embodiments, the uptake rate ratio is greater than or equal to 3.0. In some embodiments, the uptake rate ratio is greater than or equal to 4.0. In some embodiments, the uptake rate ratio is greater than or equal to 5.0.

Still yet further, the present invention broadly comprises a computer hard drive including a sorbent article including a base, formed from a resin bonded sorbent composition and having a first volume of the resin bonded sorbent composition used to form the sorbent article and a first surface area equal to a first total area of exposed surfaces of the first volume, a capacity ratio of the first volume to a second volume greater than or equal to 0.5, and an uptake rate ratio greater than or equal to 2.0. The uptake rate ratio is calculated according to the equation:

$$α = \frac{{SA}_{1} / {V}_{1}}{{SA}_{2} / {V}_{2}} ,$$

wherein: α is the uptake rate ratio, SA₁ is the first surface area, V₁ is the first volume, SA₂ is a second surface area, V₂ is the second volume. A comparative sorbent article comprises the second volume and the second surface area, the second volume includes only flat surfaces, convex surfaces or combinations thereof and being a minimum volume necessary to inscribe the first volume and the second surface area equal to a second total area of exposed surfaces of the second volume.

In some embodiments, the base includes an exposed surface area having only flat surfaces, convex surfaces or combinations thereof and the sorbent article further includes at least one of: a protrusion extending from the exposed surface area of the base; and/or, a partial bore extending into the exposed surface area of the base. In some embodiments, the sorbent article further includes at least one of: a protrusion extending from the base; a through bore within the base; and/or, a partial bore extending into the base.

Yet further, the present invention broadly comprises a sorbent article formed from a resin bonded sorbent composition including a cylindrical base having an exposed surface area including only flat surfaces, convex surfaces or combinations thereof, a plurality of substantially planar surfaces extending generally perpendicularly from the exposed surface the cylindrical base, each of the plurality of substantially planar surfaces being generally parallel to each adjacent substantially planar surface, each of the plurality of substantially planar surfaces includes at least one protrusion extending generally towards an adjacent substantially planar surface, and a sidewall extending generally perpendicularly from a circumferential edge of the cylindrical base.

For purposes of this invention the expression “resin bonded sorbent”, as appearing in the specification and claims, is intended to mean a surface compatibility occurring between the sorbent and the resin through at least a partial loss of crystallinity of the resin, whereby the sorbent becomes wetted and more miscible with the resin due to a reduction in interfacial tension. The expression “resin bonded sorbent” is intended to include binding between the resin and sorbent, which can occur, for example, through heating the sorbent with the resin, or which can be bound through suitable, non-contaminating coupling, surfactant or compatibilizing agents, discussed in greater detail below. Additionally, the term “resin” as used in blends of resin/sorbent material means the resin in the matrix, including but not limited to thermoset resins, thermoplastic resins and elastomeric resins, whereas “sorbent” means the material actually adsorbing or absorbing contaminants which may itself be a polymeric or resinous material. Resin bonded sorbents are fully described in U.S. Pat. Nos. 7,595,278 and 7,989,388, the disclosures of which are incorporated by reference herein in their entireties.

Other objects, features and advantages of one or more embodiments will be readily appreciable from the following detailed description and from the accompanying drawings and claims.

### BRIEF DESCRIPTION OF THE DRAWINGS

Various embodiments are disclosed, by way of example only, with reference to the accompanying drawings in which corresponding reference symbols indicate corresponding parts, in which:

FIG. 1 is a perspective view of a prior art sorbent article;

FIG. 2 is a perspective view of an embodiment of a present invention sorbent article;

FIG. 3 is a perspective view of an embodiment of a present invention sorbent article;

FIG. 4 is a graph depicting the performance of an example of a present invention sorbent article as compared to a conventional sorbent article;

FIG. 5A is a bottom plan view of an embodiment of present invention sorbent article;

FIG. 5B is a side elevational view of an embodiment of the sorbent article of FIG. 5A;

FIG. 5C is a top plan view of an embodiment of the sorbent article of FIG. 5A;

FIG. 5D is a bottom perspective view of the sorbent article of FIG. 5A;

FIG. 5E is a top perspective view of the sorbent article of FIG. 5A;

FIG. 6A is a bottom plan view of an embodiment of present invention sorbent article;

FIG. 6B is a side elevational view of an embodiment of the sorbent article of FIG. 6A;

FIG. 6C is a top plan view of an embodiment of the sorbent article of FIG. 6A;

FIG. 6D is a bottom perspective view of the sorbent article of FIG. 6A;

FIG. 6E is a top perspective view of the sorbent article of FIG. 6A;

FIG. 7A is a bottom plan view of an embodiment of present invention sorbent article;

FIG. 7B is a side elevational view of an embodiment of the sorbent article of FIG. 7A;

FIG. 7C is a top plan view of an embodiment of the sorbent article of FIG. 7A;

FIG. 7D is a bottom perspective view of the sorbent article of FIG. 7A;

FIG. 7E is a top perspective view of the sorbent article of FIG. 7A;

FIG. 8A is a bottom plan view of an embodiment of present invention sorbent article;

FIG. 8B is a side elevational view of an embodiment of the sorbent article of FIG. 8A;

FIG. 8C is a top plan view of an embodiment of the sorbent article of FIG. 8A;

FIG. 8D is a bottom perspective view of the sorbent article of FIG. 8A;

FIG. 8E is a top perspective view of the sorbent article of FIG. 8A;

FIG. 9A is a bottom plan view of an embodiment of present invention sorbent article;

FIG. 9B is a side elevational view of an embodiment of the sorbent article of FIG. 9A;

FIG. 9C is a top plan view of an embodiment of the sorbent article of FIG. 9A;

FIG. 9D is a bottom perspective view of the sorbent article of FIG. 9A;

FIG. 9E is a top perspective view of the sorbent article of FIG. 9A;

FIG. 10A is a bottom plan view of an embodiment of present invention sorbent article;

FIG. 10B is a side elevational view of an embodiment of the sorbent article of FIG. 10A;

FIG. 10C is a top plan view of an embodiment of the sorbent article of FIG. 10A;

FIG. 10D is a bottom perspective view of the sorbent article of FIG. 10A;

FIG. 10E is a top perspective view of the sorbent article of FIG. 10A;

FIG. 11A is a bottom plan view of an embodiment of present invention sorbent article;

FIG. 11B is a side elevational view of an embodiment of the sorbent article of FIG. 11A;

FIG. 11C is a top plan view of an embodiment of the sorbent article of FIG. 11A;

FIG. 11D is a bottom perspective view of the sorbent article of FIG. 11A;

FIG. 11E is a top perspective view of the sorbent article of FIG. 11A;

FIG. 12A is a bottom plan view of an embodiment of present invention sorbent article;

FIG. 12B is a side elevational view of an embodiment of the sorbent article of FIG. 12A;

FIG. 12C is a top plan view of an embodiment of the sorbent article of FIG. 12A;

FIG. 12D is a bottom perspective view of the sorbent article of FIG. 12A;

FIG. 12E is a top perspective view of the sorbent article of FIG. 12A;

FIG. 13A is a bottom plan view of an embodiment of present invention sorbent article;

FIG. 13B is a side elevational view of an embodiment of the sorbent article of FIG. 13A;

FIG. 13C is a top plan view of an embodiment of the sorbent article of FIG. 13A;

FIG. 13D is a bottom perspective view of the sorbent article of FIG. 13A;

FIG. 13E is a top perspective view of the sorbent article of FIG. 13A;

FIG. 14A is a bottom plan view of an embodiment of present invention sorbent article;

FIG. 14B is a side elevational view of an embodiment of the sorbent article of FIG. 14A;

FIG. 14C is a top plan view of an embodiment of the sorbent article of FIG. 14A;

FIG. 14D is a bottom perspective view of the sorbent article of FIG. 14A;

FIG. 14E is a top perspective view of the sorbent article of FIG. 14A;

FIG. 15A is a top perspective view of a volume which inscribes the sorbent article of FIGS. 9A-9E;

FIG. 15B is a top perspective view of a volume which inscribes the sorbent article of FIGS. 9A-9E showing the sorbent article of FIGS. 9A-9E in broken lines; and,

FIG. 16 is a cross sectional view of an embodiment of a present invention sorbent article.

### DETAILED DESCRIPTION

At the outset, it should be appreciated that like drawing numbers on different drawing views identify identical, or functionally similar, structural elements of the embodiments set forth herein. Furthermore, it is understood that these embodiments are not limited to the particular methodology, materials and modifications described and as such may, of course, vary. It is also understood that the terminology used herein is for the purpose of describing particular aspects only, and is not intended to limit the scope of the disclosed embodiments, which are limited only by the appended claims.

Unless defined otherwise, all technical and scientific terms used herein have the same meaning as commonly understood to one of ordinary skill in the art to which these embodiments belong. As one of ordinary skill in the art appreciates, the term “fluid” is defined as an aggregate of matter in which the molecules are able to flow past each other without limit and without fracture planes forming. “Fluid” can be used to describe, for example, liquids, gases and vapors. Additionally, a salt of a CO₂ releasing anion as used herein refers to any salt that will release CO₂ vapor upon contact with an acid stronger than carbonic acid, e.g., carbonates and bicarbonates. When the term “permeable” or “impermeable” is used herein, it is intended to refer to transfer of fluid through a material either through pores therein or at a molecular level. As used herein, the term ‘average’ shall be construed broadly to include any calculation in which a result datum or decision is obtained based on a plurality of input data, which can include but is not limited to, weighted averages, yes or no decisions based on rolling inputs, etc.

Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

Moreover, although any methods, devices or materials similar or equivalent to those described herein can be used in the practice or testing of these embodiments, some embodiments of methods, devices, and materials are now described.

It would be desirable for reasons of cost and productivity to incorporate a sorbent into a resin, and in particular one suitable for injection molding, in such a way that its adsorptive properties are preserved and the molding properties of the resin are maintained without degrading mechanical properties. Surprisingly, the molding compositions and the novel parts of the invention fabricated therewith are multi-functional, beneficially combining structural, mechanical and adsorptive capabilities without requiring the usual reinforcing additives. Consequently, with the omission of reinforcing additives the molding compositions are further characterized by higher moisture adsorptive capacities by allowing for higher sorbent loading factors than prior adsorbent-containing molding compositions.

Sorbents of the “resin bonded sorbent” molding compositions have the beneficial effect of imparting reinforcement to the molding compositions described herein while retaining their moisture adsorptive capacity, but without requiring the usual and customary strengthening additives, such as glass beads, glass fiber, and the like. This allows for higher loading factors of sorbent additives for maximizing adsorptive properties of the molding composition without trade-offs occurring in terms of significantly altered mechanical properties of the molding composition.

Mechanical properties of molding resins comprising sorbent additives are capable of eliminating the usual requirement specifically for reinforcement additives, such as glass beads and glass fibers. Multifunctional sorbent-resin molding compositions comprising moisture adsorbing-mechanical property enhancing amounts of adsorbent in combination with reinforcing additives and resin permit reduced amounts of reinforcing additives to be employed than otherwise normally required for enhanced mechanical properties. Resin bonded sorbents provide desiccant-containing molding compositions, but with reduced quantities of strength enhancing additives, such as glass fibers and glass beads. This will enhance the mechanical properties of the molding composition without the potential for degrading the strength characteristics of the molded article. More specifically, proportional ranges of sorbent, reinforcing additives and resin can be from about 5 to about 50 wt % sorbent; from about 0 to about 15 wt % reinforcing additive and from about 45 to about 95 wt % resin. Additionally, a resin/sorbent matrix having a blowing agent incorporated therein maintains its structural integrity while reducing material density by about 30%.

The resins can be processed and formed by several techniques, including modern high-speed injection molding processes into fully functional component parts, including parts for various sealed systems and assemblies. In these later applications, the structural and functional features are served while ambient and ingressed moisture are adsorbed to protect sensitive materials or components of systems or assemblies from degradation by moisture; e.g. hydrolysis or corrosion.

In accordance with the above, resin bonded sorbent materials comprise reinforced structural resin compositions suitable for injection molding with improved mechanical properties, satisfactory melt handling properties, and substantial moisture adsorption properties. Most thermoplastic resins are suitable for use in the resin bonded adsorbent compositions of the invention, and include homopolymers and copolymers comprising two or more monomers. Representative examples include the polyamides, such as Nylon 6; Nylon 6,6; Nylon 610, and so on. Other representative examples include the polyolefins, such as high and low density polyethylenes, polypropylene; copolymers of ethylene-vinyl acetate; polystyrene; polyesters, e.g., PET, to name but a few. Additionally, thermosetting resins and elastomeric resins may be used.

As previously discussed, compositions used to form the present invention sorbent article may comprise from about 5 to about 55 wt % sorbent and the balance resin, and more specifically, from about 25 to about 45 wt % sorbent with the balance resin. More preferred compositions may comprise from about 35 to about 42 wt % sorbent, such as a molecular sieve, and the balance resin. A most preferred resin bonded sorbent composition may comprise from about 60% nylon molding resin, such as Zytel® 101, commercially available from E.I. duPont, compounded with 40% molecular sieve, such as W. R. Grace 4A molecular sieve powder. The molecular sieves of the invention can have a nominal pore size of 4 Å, and a particle size range of about 0.4 to about 32μ. It is to be noted, however, that other molecular sieve pore-sizes can be used as well, such as 3 Å, 5 Å, or 10 Å, for example.

Generally, sorbents which are useful and functional in resin bonded sorbents are those which bond mechanically to the resin without special additives, such as molecular sieve, as previously discussed. Still others, can be induced to bond to the resin through use of a suitable additive, i.e., bind with the aid of a coupling or compatibilizing agent. In addition to molecular sieve, other representative sorbents that are useful in the compositions used in the present invention include silica gel, activated carbon, activated alumina, clay, other natural zeolites, and combinations thereof. Those sorbents found to perform with coupling or compatibilizing agents include such members as activated carbon and alumina. Moreover, in the present invention, sorbents are not limited to those which adsorb or absorb moisture, but also include sorbents capable of adsorbing or absorbing oxygen, volatile organic solvents, and any other fluid type desired to be removed from a working environment in which a present invention sorbent article is included.

The additives which perform as compatibilizers fall into either of two categories, namely those which bond with the resin or the sorbent and act as coupling agents, and those having some affinity with both resin and sorbent and act as solid state surfactants. Reactive coupling agents include such classes as maleates, epoxies, various organically functionalized zirconates and titanates, and silanes. More specifically, reactive coupling agents include such representative examples as maleic anhydride grafted polymers used in amounts ranging from about 2 to about 5 wt %. In particular, they can include such representative examples as maleic anhydride grafted to polypropylene or ABS resins, the latter being useful as coupling agents with styrenic polymers. Similarly, silanes with various functional groups attached may be used.

Resin bonded sorbents may also include so called non-reactive type compatibilizing agents in binding sorbent and resin. This comprises such representative examples as metals (e.g., zinc or sodium), acrylates, stearates and block copolymers, e.g., zinc stearate, sodium stearate in a typical range from about 0.01 to about 0.02 wt % based of the sorbent. The actual level is driven by the surface area, which is in-turn proportional to the particle size. For a molecular sieve with mean particle size of 10μ, 100 ppm of aluminum stearate would be a typical starting level for compatibilization with a polyamide resin. With both reactive and non-reactive coupling/compatibilizing agents, their incorporation within the resin matrix does not create phase boundaries.

The resin bonded sorbent compositions utilized in forming the present invention may be formed by plastic compounding techniques generally familiar among ordinary skilled artisans. Molecular sieve, a preferred sorbent, may be incorporated into the resin, e.g., polyamide, polyolefin, or the like, by feeding the sorbent in powdered format along with beads of the chosen resin to a plastics extruder with good mixing characteristics. Although single-screw extruders may be used to compound a resin and sorbent, a resin and sorbent blend normally needs to be double-compounded in a twin-screw extruder in order to produce a suitable resin bonded sorbent material. Even after double compounding, phase separation sometimes occurs due to a lack of sufficient compatibilization. It has been found that resin bonded sorbent materials compounded with twin-screw extrusion equipment with extensive back mixing is needed to attain nearly complete dispersion of the sorbent and develop the superior mechanical and physical characteristics which are an object of this invention. In other words, resin bonded sorbent materials formed via a twin-screw extruder show little or no migration of sorbent within the resin matrix and thus these resin bonded sorbent materials maintain a homogeneous appearance. Therefore, twin-screw extruder compounding is typically used to form resin bonded sorbent materials used in forming the present invention sorbent article, as the resin is melted and the sorbent mixed throughout. It is a necessary condition that the melt blend be heated above the melt point of the resin as determined by DSC (differential scanning calorimetry). That is, in preparing the resin bonded sorbents for use in the present invention, the temperature should be raised to the point where all crystallinity is lost in order to achieve complete miscibility of the sorbent in the resin melt. For example, DuPont's Zytel® 101 polyamide resin would be heated above 262° C. The extruded resin is cooled and then cut or crushed into pellets or granules. Because compounding is performed at elevated temperatures above typical fluid boiling points, the sorbent tends not to adsorb moisture during this processing period, but retains its adsorption capacity when molded into a present invention component part and installed in a working environment.

One further advantage realized with the resin bonded sorbent system, wherein the resin and sorbent are intimately bonded, is that gram for gram it is more effective than adsorbent systems employing a bagged adsorbent, i.e., adsorbent capacity per unit volume. According to earlier methods wherein bags were used for containerizing sorbent, the sorbent required beading to prevent it from entering the working environment. This required the sorbent to be bonded within a binder resin, typically 15 wt % binder, such as in the form of a powder. Thus, when 40 grams of a commercially prepared sorbent was placed into a bag, in reality only 34 grams of sorbent were introduced into the system (with 6 grams of binder). Beaded formulations also tend to have a larger effective volume per unit weight due to imperfect packing of beads and formation of free volume occupied by air. In contradistinction, resin bonded sorbents require no additional binder resin because the sorbent is placed directly into the molding resin from which the present invention components are fabricated. Advantageously, no intermediary binder resin is required, allowing for higher sorbent loading factors than otherwise achieved with the usual bagged sorbents.

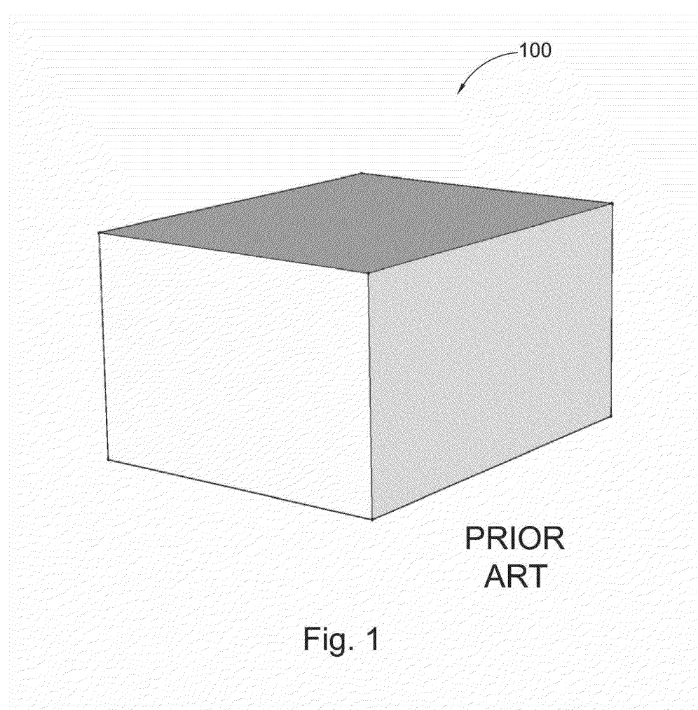

The compounded resin and sorbent blend previously discussed can be extruded into a sheet or film, or injection molded in the form of a part. An example of a known use of resin bonded sorbent is shown in FIG. 1. Molded block 100 is formed from the above described resin bonded sorbent material. The strength of the silicate-reinforced resin results in a structurally sound molded part. As such, it is self-supporting and suitable for mounting in a working environment. Thus, block 100 can be used in a variety of ways, including but not limited to, being placed in a working environment or being used as a structural component within a working environment. Block 100 provides a means of drying a working environment, in particular, an enclosed working environment.

It has been found that the rate of fluid uptake is dependent upon the amount of exposed surface area of a molded article in combination with the sorbent loading value. In other words, based on application needs, the amount of exposed surface area relative to sorbent loading can be optimized. It is believed that sorbent loading affects not only the rate of fluid uptake but also the total quantity of fluid that may ultimately be adsorbed or absorbed by the molded article, i.e., the higher the sorbent loading, the greater quantity of fluid captured over an extended period of time. It should be noted that the rate of fluid uptake is also dependent on the particular selection of resin and sorbent materials. Such relationships are defined in U.S. Pat. No. 8,034,739, the disclosure of which is incorporated by reference herein in its entirety. Moreover, based on application needs, the amount of fast acting surface area relative to slow acting surface area or bulk composite volume located remotely from the fast acting surfaces can be optimized.

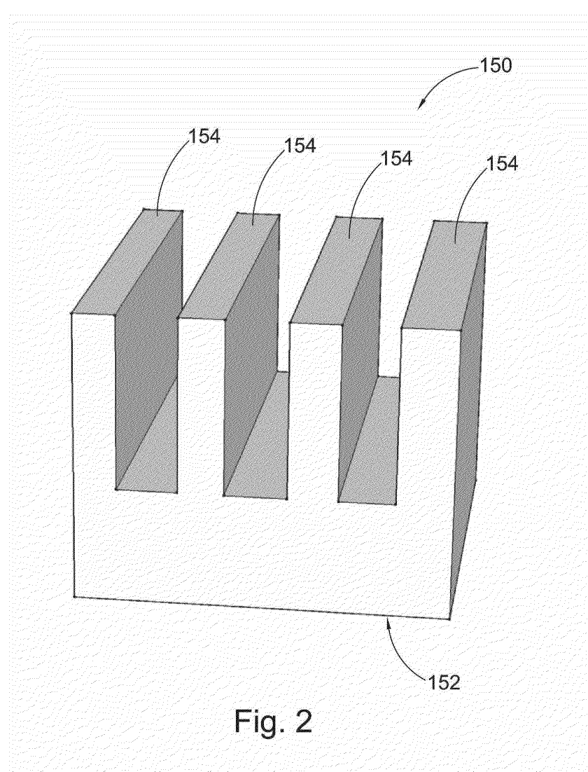

FIG. 2 shows a perspective view of an embodiment of the present invention, i.e., molded article 150. Article 150 includes solid block portion 152 and fins 154. Article 150 may be molded in the shape depicted or may begin as a monolithic block which is subsequently machined to include fins 154, e.g., saw cutting a monolithic block. As can be appreciated by a visual comparison of block 100 versus article 150, article 150 has a greater surface area than block 100. The greater surface area, in particular fins 154, permits a more rapid uptake of fluid, which as mentioned above, is believed to be related to the exposed surface area. In addition to the rapid uptake provided by fins 154, block portion 152 provides ongoing, slow uptake of fluid thereby permitting article 150 to capture fluid in a working environment over an extended period of time. Thus, it has been found that the combination of a high surface area portion, e.g., fins 154, and a lower surface area portion or bulk volume without exposed surfaces, e.g., block portion 152, provides a dual purpose sorbent article capable of rapid initial uptake of a fluid followed by slower consistent uptake of a fluid over an extended period of time.

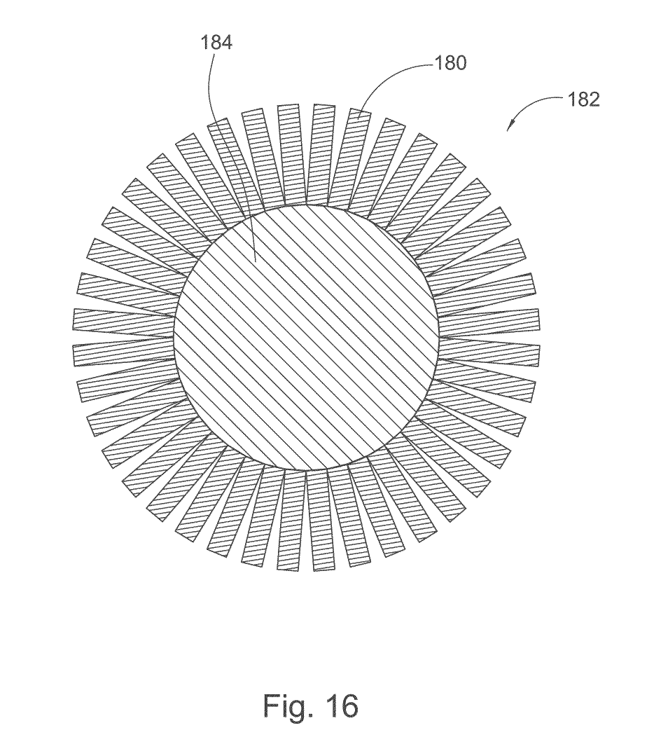

The present invention sorbent articles may be formed by injection molding the higher and lower surface area portions, may be milled or otherwise formed or pelletized into pieces which are then sintered into parts, such as a flow-through monolith structure, or a flow-through dryer component, e.g., electronics filtration for a hard drive. In this case, the sorbent article is not injection molded, but is molded from the compounded sorbent-loaded resin into a functional part having sufficient porosity for its intended application, such as for use in a receiver dryer assembly. In all embodiments, the present invention sorbent article includes both a higher surface area portion and a lower surface area portion. It should be appreciated that as used herein “higher surface area” is intended to mean an increased amount of the surface area over the amount that would be present if the molded article were a monolithic structure devoid of additional surface features. “Lower surface area” is also intended to include bulk material volume without any exposed surfaces and having significantly larger thickness or other dimensions located away from the exposed surfaces than the average thickness of the features with high surface area. FIG. 16 illustrates one example of a representative shape of a starburst type where all higher surface area is concentrated in the “ray” parts, i.e., projecting cylinders 180, of article 182 while central sphere 184, without any exposed surfaces, constitutes the lower surface area portion. It should be appreciated that FIG. 16 is a cross sectional view of article 182 and that the object depicted is a three-dimensional sphere having a plurality of cylinders projecting outwardly therefrom about its entire surface. For the sake of clarity, only the cross section is shown so that the characteristic of no exposed surface area on central sphere 184 can be more readily understood. Furthermore, depending on the application requirements, a lower surface area portion of a part may be set or fit into an impermeable preformed cavity in a device, effectively reducing its exposed surface to zero. This portion will continue to act as a low surface area portion by slowly absorbing a fluid permeating through the high surface area parts.

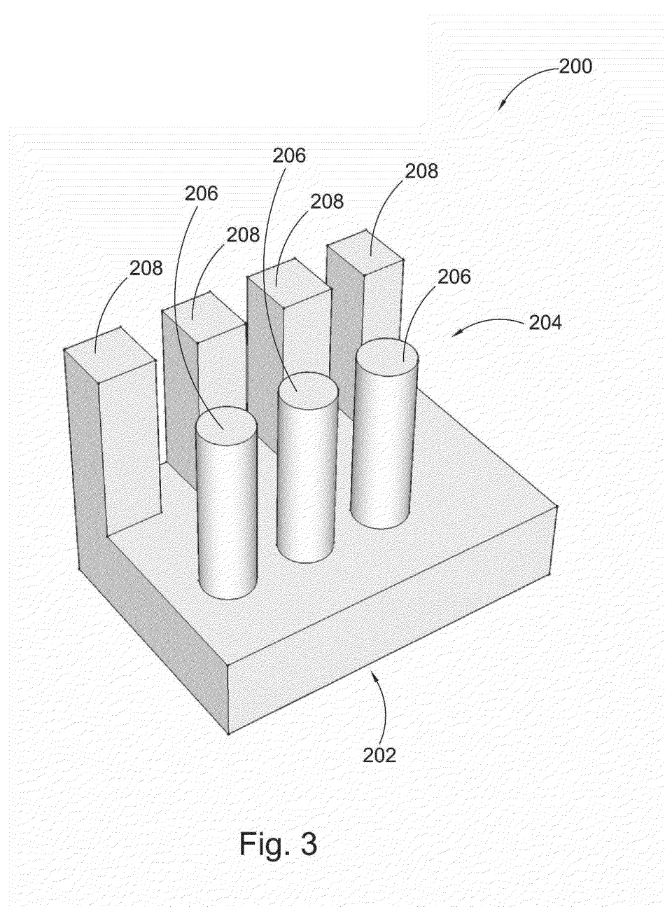

FIG. 3 shows an embodiment of the present invention sorbent article, i.e., article 200, having lower surface area portion 202 and high surface area portion 204. In this embodiment, higher surface area portion 204 comprises alternate embodiments than previously disclosed, i.e., columns 206 and protrusions 208. It should be appreciated that the present invention sorbent article is not limited to the forms depicted in the figures and therefore may take a variety of other forms, e.g., corrugation, spun deposition (spaghetti like structure), etc.

Present invention sorbent articles are particularly well suited to replace multiple-component parts of the prior art. For example, in the past many specialized structures have been developed to fit and secure a desiccant material (which was loose) in various parts of a working environment. Welded or sewn bags containing beaded or granular molecular sieve or aluminum oxide would be disposed within the working environment. Additionally, and specifically with respect to stationary refrigeration applications, beads or granules of desiccant were bonded together in a heated mold with a suitable heat-cured resin or ceramic binder to produce a rigid shape which would serve as a drying block or partial filter. Such a structure would be built into a housing. These solutions, however, involved complicated multiple part pieces. The present invention, however, joins the performance of the long working life sorbent article with a rapid uptake sorbent article such that a one-piece device serves both functions simultaneously.

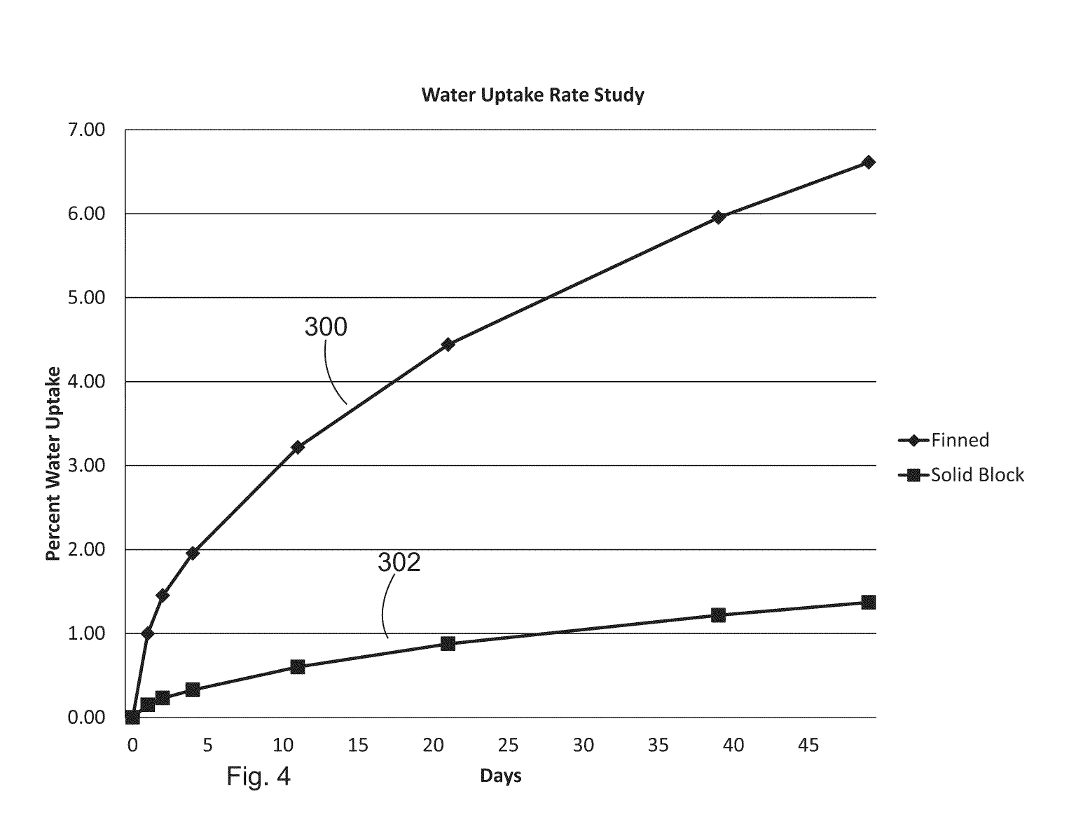

The following example demonstrates the benefit of the present invention sorbent article over known monolithic structures, and structures comprising constant wall thicknesses throughout the entire structure. Two structures were compared in the example, one substantially similar to the structure depicted in FIG. 1, i.e., the “standard” block, and one substantially similar to the structure depicted in FIG. 2, i.e., the “finned” block. The blocks were formed from a resin bonded sorbent composition comprising 60 wt % Nylon 6/6 and 40 wt % molecular sieve. After forming two identical blocks, one block was saw cut in order to form a plurality of fins or protrusions. Both blocks were then placed in an environmental chamber held at a constant 25 deg. Centigrade and 85% relative humidity. The following tables show how each block performed, i.e., Table 1 is the performance of the “standard” block and Table 2 is the performance of the “finned” block. FIG. 4 depicts the water uptake of each block as a percentage increase over the original weight. In FIG. 4, line 300 corresponds to the present invention “finned” block and line 302 corresponds to the prior art “standard” block.

TABLE 1

| | | | Change in | Wt % |
|---|---|---|---|---|
| | Number of | | Mass (g) | water |
| Date | days | Block Mass (g) | from previous | uptake |
| Jun. 11, 2012 | 0 | 111.8171 | 0.0000 | 0.00 |
| Jun. 12, 2012 | 1 | 111.9866 | 0.1695 | 0.15 |
| Jun. 13, 2012 | 2 | 112.0758 | 0.0892 | 0.23 |
| Jun. 15, 2012 | 4 | 112.1854 | 0.1096 | 0.33 |
| Jun. 22, 2012 | 11 | 112.4905 | 0.3051 | 0.60 |
| Jul. 2, 2012 | 21 | 112.7968 | 0.3063 | 0.88 |
| Jul. 20, 2012 | 39 | 113.1782 | 0.3814 | 1.22 |
| Jul. 30, 2012 | 49 | 113.3491 | 0.1709 | 1.37 |

TABLE 2

| | | | | Wt % |
|---|---|---|---|---|
| | | | Change in | water |
| Date | Number of days | Block Mass (g) | Mass (g) | uptake |
| Jun. 11, 2012 | 0 | 71.0435 | 0.0000 | 0.00 |
| Jun. 12, 2012 | 1 | 71.7522 | 0.7087 | 1.00 |
| Jun. 13, 2012 | 2 | 72.0754 | 0.3232 | 1.45 |
| Jun. 15, 2012 | 4 | 72.4332 | 0.3578 | 1.96 |
| Jun. 22, 2012 | 11 | 73.3294 | 0.8962 | 3.22 |
| Jul. 2, 2012 | 21 | 74.1996 | 0.8702 | 4.44 |
| Jul. 20, 2012 | 39 | 75.2738 | 1.0742 | 5.95 |
| Jul. 30, 2012 | 49 | 75.7416 | 0.4678 | 6.61 |

The performance of a resin/sorbent composition, i.e., rate of uptake and total capacity, is dependent on the type of resin and the quantity of loading of sorbent. Additionally, as described above, increasing the exposed surface area of one of two formed sorbent articles constructed from the same resin/sorbent composition increases the initial uptake rate of that article relative to the unmodified sorbent article. Moreover, the overall capacity to absorb or adsorb is dependent on the overall volume of a particular resin/sorbent composition used to form a sorbent article. Thus, as the volume decreases, the capacity decreases, and as the volume increases, the capacity increases. In the context of the articles depicted in FIGS. 1 and 2, article 100 has a greater volume than article 150 and therefore article 100 has a greater capacity to absorb or adsorb fluid than article 150. Contrarily, article 150 has a greater exposed surface area than article 100 and therefore the initial uptake rate of article 150 is greater than that of article 100. It should be appreciated that the uptake rate for any formed sorbent article will change over time, i.e., generally, as the quantity of adsorbed or absorbed fluid increases the uptake rate decreases largely due to sorbent capacity saturation in the areas closest to the exposed surfaces and diffusion rate driven resistance to further fluid permeation into the bulk material.

The size and shape of a formed sorbent article is often dictated by its end use. For example, sorbent articles are incorporated within hard drive devices. Such sorbent articles must maintain a small overall package size while providing two sorbent characteristics important to the application, i.e., fast initial uptake to dry the enclosure at assembly (exposed surface area of the sorbent article) and continued uptake over a prolonged service life of the product (volume of the sorbent article). It has been found that a balance must be maintained between increasing the amount of exposed surface area of the article while decreasing its overall volume. In short, the exposed surface area must be sufficient enough to provide the desired initial drying or uptake rate and the volume must be sufficient enough to provide the desired adsorbing/absorbing capacity for the lifetime of the sorbent article.

Serendipitously, the present inventors have discovered a means to determine if a formed sorbent article will be capable of satisfying the foregoing criteria using the following ratios. A formed sorbent article will satisfy the capacity requirement if the following ratio is met:

$$γ = \frac{{v}_{part}}{{v}_{inscribe}} > 0.5$$

wherein:
   γ is the capacity ratio
   Vₚₐᵣₜ is the volume of the formed sorbent article
   V_{inscribe} is the minimum volume comprising only flat surfaces, convex surfaces or combinations thereof necessary to inscribe the volume of the formed sorbent article.
      A formed sorbent article will satisfy the uptake rate requirement if the following ratio is met:

$$α = \frac{{SA}_{part} / {V}_{part}}{{SA}_{inscribe} / {V}_{inscribe}} > 2.0$$

wherein:
   α is the uptake rate ratio
   SAₚₐᵣₜ is the exposed surface area of the formed sorbent article
   Vₚₐᵣₜ is the volume of the formed sorbent article
   SA_{inscribe} is the exposed surface area of the minimum standard three dimensional shape necessary to inscribe the volume of the formed sorbent article
   V_{inscribe} is the minimum volume comprising only flat surfaces, convex surfaces or combinations thereof necessary to inscribe the volume of the formed sorbent article.

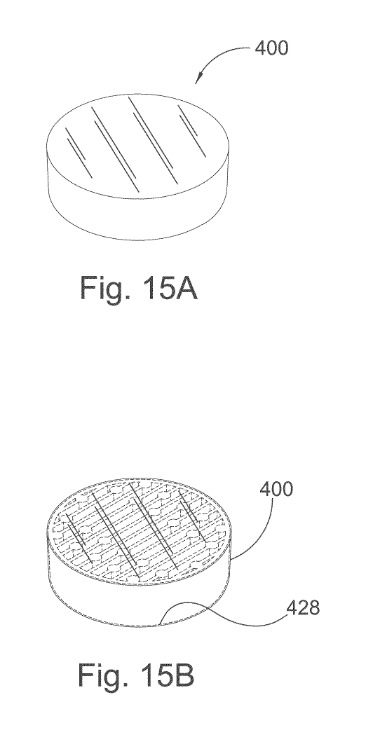

It should be noted that the “exposed surface area” as used herein is intended to mean all or partial surface area of a part actually exposed to the constrained environment. Part surfaces blocked by the enclosure walls and the like generally do not contribute to the absorption rate. It should be appreciated that as used herein the “minimum standard three dimensional shape necessary to inscribe the volume of the formed sorbent article” is intended to mean a standard three dimensional shape having the smallest possible volume that inscribes the formed sorbent article. For example, article 100 depicted in FIG. 1 is the minimum standard three dimensional shape that inscribes article 150. Similarly, as shown in FIG. 15B, article 400 is the minimum standard three dimensional shape that inscribes articles 402, 404, 406, 408, 410, 412, 414, 416, 418 and 420. Such standard three dimensional shapes include but are not limited to convex regular polyhedrons, prisms, cylinders, spheres, ellipsoids, cones, and pyramids. Moreover, such shapes may also be described as the smallest possible volume having only flat surfaces, convex surfaces or combinations thereof.

For the purpose of further description of the foregoing ratios, Table 3 summarizes the surface areas and volumes of articles 402, 404, 406, 408, 410, 412, 414, 416, 418 and 420 and the associated calculated capacity and uptake rate ratios. It should be appreciated that Table 3 below demonstrates that some configurations possess the necessary balance between volume and surface area, e.g., articles 404, 406, 408, 410, 416 and 420, while the remaining configurations do not possess the necessary balance between volume and surface area, e.g., articles 402, 412, 414 and 418.

TABLE 3

| Disk | Exposed Surface | Volume | Capacity | Uptake Rate |
|---|---|---|---|---|
| Embodiment | Area (inches²) | (inches) | Ratio | Ratio |
| article 402 | 2.49086 | 0.10339 | 0.68775 | 1.91640 |
| article 404 | 2.55897 | 0.09782 | 0.65070 | 2.08091 |
| article 406 | 2.94056 | 0.10630 | 0.70711 | 2.20045 |
| article 408 | 5.08858 | 0.09479 | 0.63055 | 4.27021 |
| article 410 | 5.74587 | 0.09078 | 0.60387 | 5.03479 |
| article 412 | 2.34581 | 0.12430 | 0.82685 | 1.50119 |
| article 414 | 2.40140 | 0.12139 | 0.80749 | 1.57361 |
| article 416 | 4.55160 | 0.12140 | 0.80756 | 2.98236 |
| article 418 | 2.77735 | 0.06358 | 0.42294 | 3.47477 |
| article 420 | 3.35286 | 0.10409 | 0.69241 | 2.56225 |

Article 400 used to calculate the foregoing ratios in Table 3 has a diameter of seven eighths (⅞) of an inch and a height of one quarter (¼) of an inch. The dimensions of article 400 and the surface areas and volumes of articles 402, 404, 406, 408, 410, 412, 414, 416, 418 and 420 are included for discussion and demonstration purposes only and do not limit the scope of the claimed invention.

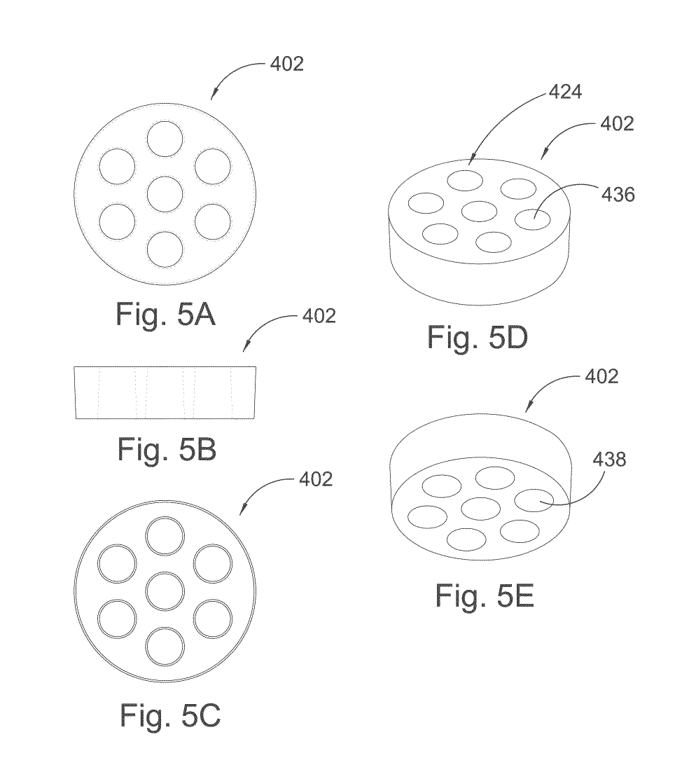

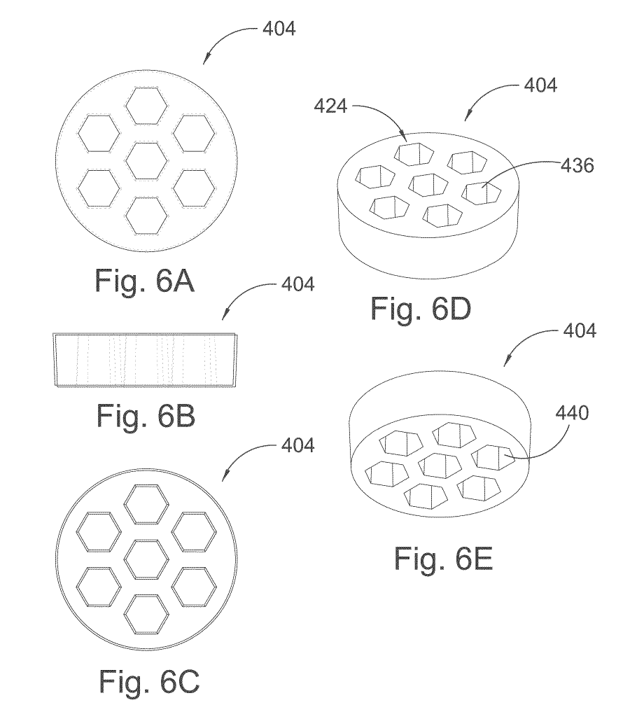

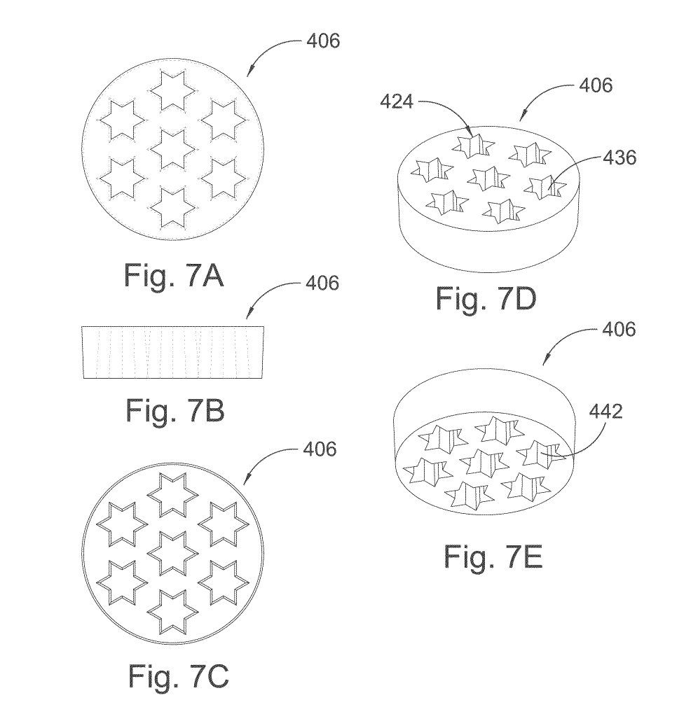

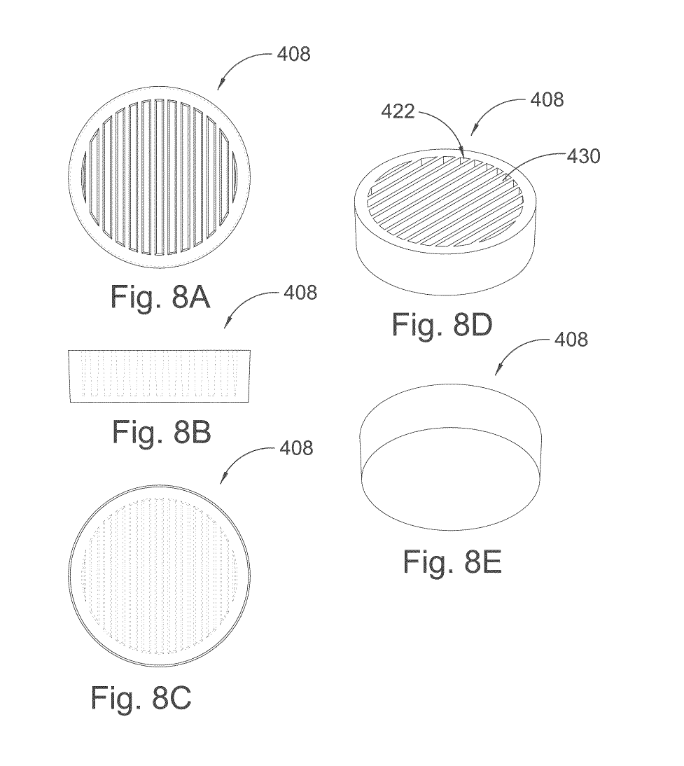

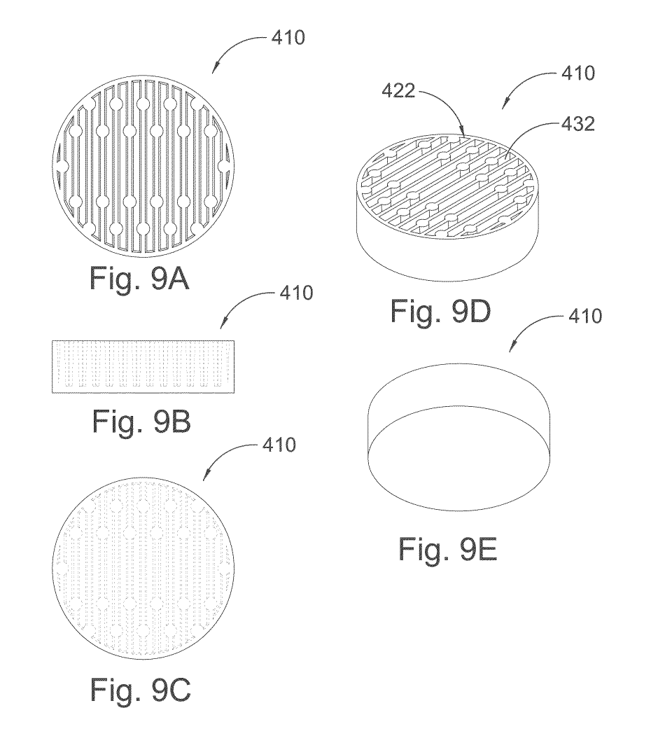

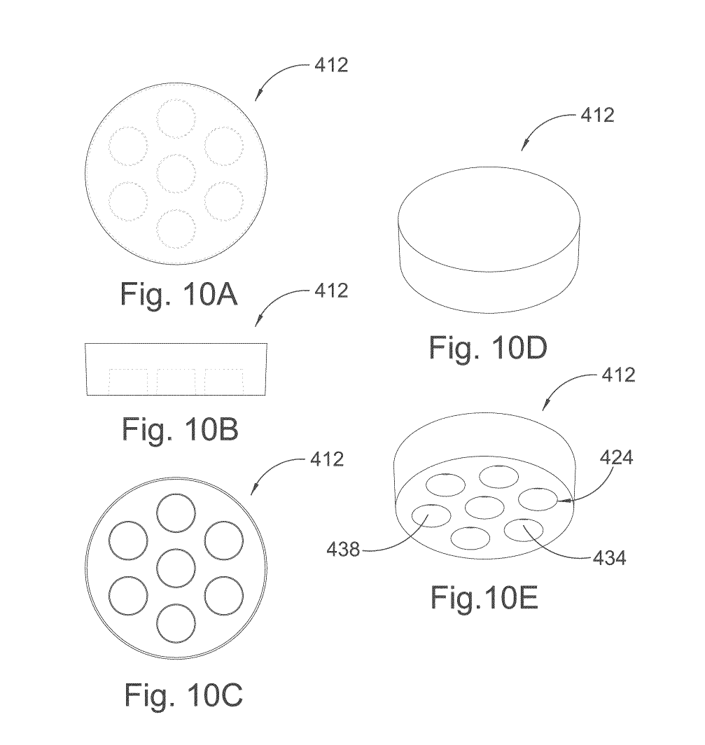

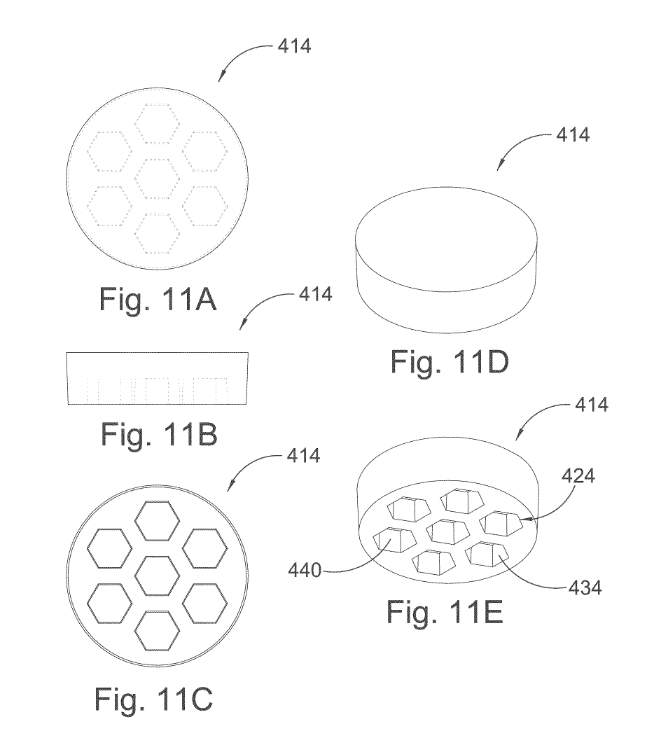

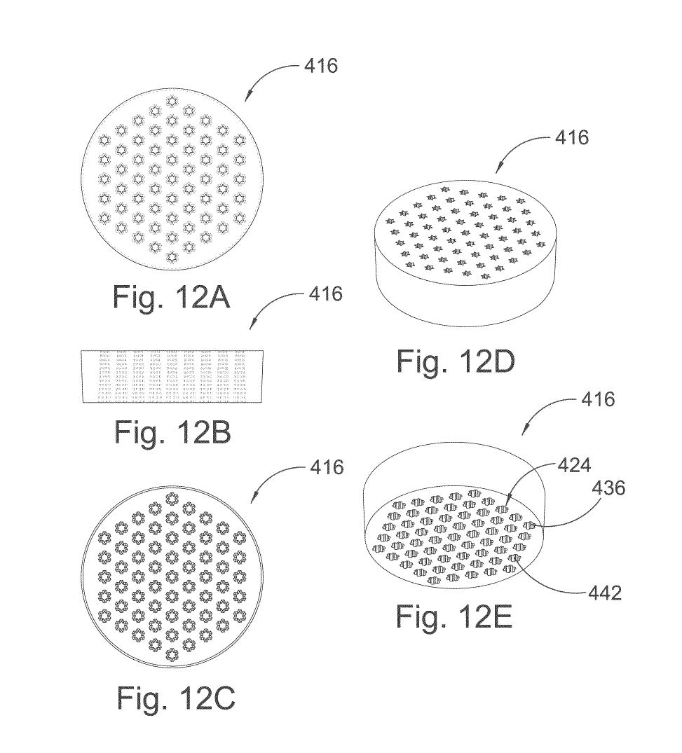

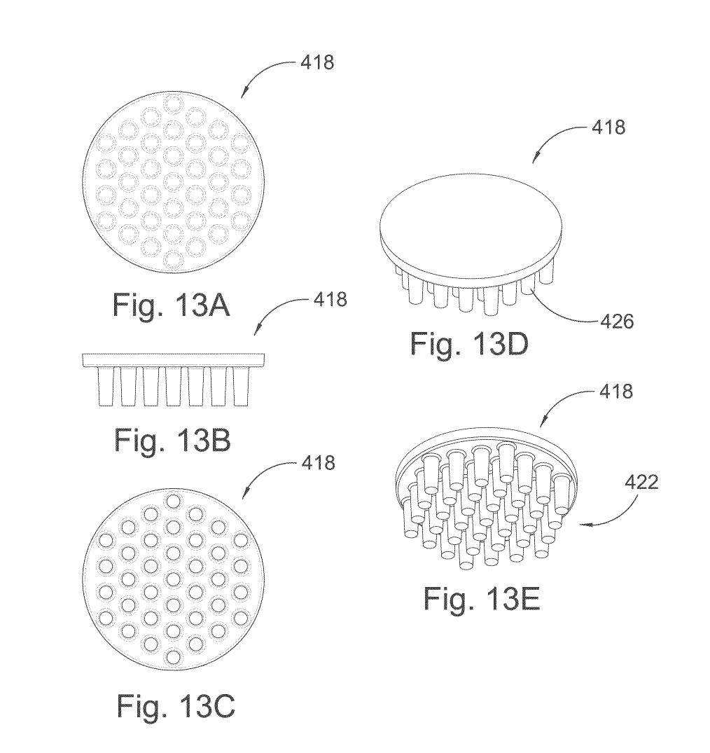

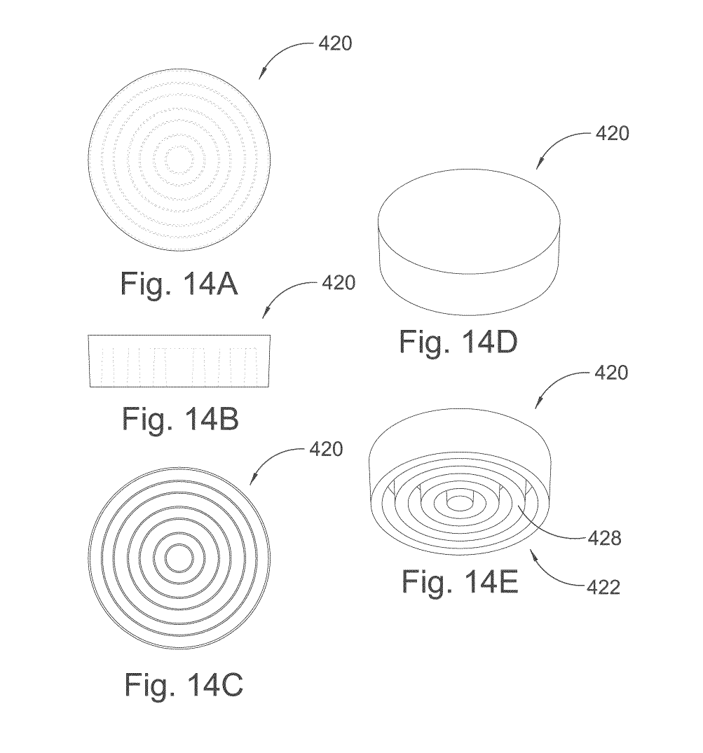

As can be seen in FIGS. 2, 3 and 5A-14E, formed sorbent articles may comprise a variety of shapes, e.g., cuboids (See, e.g., FIGS. 2 and 3), spheres, cylinders (See, e.g., FIGS. 5A-14E), wave shaped pattern, helical, etc., and may include a variety of features used to increase surface area, e.g., protrusions (See, e.g., protrusions 422), bores (See, e.g., bores 424), etc. Protrusions may include but are not limited to cones, cylinders 426, concentric circles 428, fins 430 and fins with supports 432. Bores may include but are not limited to tapered and non-tapered bores, partial and through bores (See, e.g., bores 434 and 436, respectively), and may include cross sectional shapes such as circles (See, e.g., bores 438), polygons (See, e.g., bores 440) and stars (See, e.g., bores 442). One of ordinary skill in the art will appreciate that other shapes of the article, e.g., spirals, snake-like folds, etc., shapes of the protrusions and shapes of the bores are also possible and such variations are within the scope of the claims. It should be further appreciated that as used herein “wave shaped pattern” is intended to mean a series of repetitions in a material which may be corrugations, sinusoidal or may have acute, curved or flat peaks with connecting side portions, such as the shape of ribbon candy or corrugated cardboard. Moreover, as used herein, “helical” is intended to mean a curve in three-dimensional space, and may include but is not limited to single helix, double helix, conic helix, circular helix, etc.

It will be appreciated that various of the above-disclosed and other features and functions, or alternatives thereof, may be desirably combined into many other different systems or applications. Various presently unforeseen or unanticipated alternatives, modifications, variations or improvements therein may be subsequently made by those skilled in the art which are also intended to be encompassed by the following claims.

What we claim is:

1. A sorbent article formed from a resin bonded sorbent composition and having a first volume of the resin bonded sorbent composition used to form the sorbent article and a first surface area equal to a first total area of exposed surfaces of the first volume, the sorbent article comprising:
a base comprising an exposed surface area having only flat surfaces, convex surfaces or combinations thereof;
at least one of: a protrusion extending from the exposed surface area of the base; and/or, a partial bore extending into the exposed surface area of the base;
a capacity ratio of the first volume to a second volume greater than or equal to 0.5; and,
an uptake rate ratio greater than or equal to 2.0, wherein the uptake rate ratio is calculated according to the equation:
$$α = \frac{{SA}_{1} / {V}_{1}}{{SA}_{2} / {V}_{2}} ,$$
wherein:
α is the uptake rate ratio
SA₁ is the first surface area
V₁ is the first volume
SA₂ is a second surface area
V₂ is the second volume,
wherein a comparative sorbent article comprises the second volume and the second surface area, the second volume comprising only flat surfaces, convex surfaces or combinations thereof and being a minimum volume necessary to inscribe the first volume and the second surface area equal to a second total area of exposed surfaces of the second volume.

2. The sorbent article of claim 1, wherein the second volume is a three dimensional shape selected from the group consisting of: a convex regular polyhedron, a prism, a cylinder, a sphere, an ellipsoid, a cone, and a pyramid.

3. The sorbent article of claim 1 further comprising a cylindrical base and at least one protrusion extending from the cylindrical base.

4. The sorbent article of claim 3 further comprising a sidewall extending generally perpendicularly from a circumferential edge of the cylindrical base.

5. The sorbent article of claim 3 wherein the at least one protrusion tapers from a first end to a second end proximate the cylindrical base.

6. The sorbent article of claim 1 further comprising a cylindrical base and at least one partial bore extending into the exposed surface area of the base.

7. The sorbent article of claim 6 wherein the at least one partial bore comprises a cross sectional shape selected from the group consisting of: a circle, a polygon, and a star, and the at least one partial bore tapers from a first end to a second end.

8. The sorbent article of claim 1 wherein the uptake rate ratio is greater than or equal to 3.0.

9. The sorbent article of claim 1 wherein the uptake rate ratio is greater than or equal to 4.0.

10. The sorbent article of claim 1 wherein the uptake rate ratio is greater than or equal to 5.0.

11. The sorbent article of claim 1 further comprising:
a cylindrical base comprising an exposed surface area having only flat surfaces, convex surfaces or combinations thereof;
a plurality of substantially planar surfaces extending generally perpendicularly from the exposed surface the cylindrical base, each of the plurality of substantially planar surfaces being generally parallel to each adjacent substantially planar surface;
each of the plurality of substantially planar surfaces comprises at least one protrusion extending generally towards an adjacent substantially planar surface; and,
a sidewall extending generally perpendicularly from a circumferential edge of the cylindrical base.

12. A sorbent article formed from a resin bonded sorbent composition and having a first volume of the resin bonded sorbent composition used to form the sorbent article and a first surface area equal to a first total area of exposed surfaces of the first volume, the sorbent article comprising:
a base;
at least one of: a protrusion extending from the base; a through bore within the base; and/or, a partial bore within the base;
a capacity ratio of the first volume to a second volume greater than or equal to 0.5; and,
an uptake rate ratio greater than or equal to 2.0, wherein the uptake rate ratio is calculated according to the equation:
$$α = \frac{{SA}_{1} / {V}_{1}}{{SA}_{2} / {V}_{2}} ,$$
wherein:
α is the uptake rate ratio
SA₁ is the first surface area
V₁ is the first volume
SA₂ is a second surface area
V₂ is the second volume,
wherein a comparative sorbent article comprises the second volume and the second surface area, the second volume comprising only flat surfaces, convex surfaces or combinations thereof and being a minimum volume necessary to inscribe the first volume and the second surface area equal to a second total area of exposed surfaces of the second volume.

13. The sorbent article of claim 12, wherein the second volume is a three dimensional shape selected from the group consisting of: a convex regular polyhedron, a prism, a cylinder, a sphere, an ellipsoid, a cone, and a pyramid.

14. The sorbent article of claim 12 further comprising a cylindrical base and at least one protrusion extending from the cylindrical base.

15. The sorbent article of claim 14 further comprising a sidewall extending generally perpendicularly from a circumferential edge of the cylindrical base.

16. The sorbent article of claim 14 wherein the at least one protrusion tapers from a first end to a second end proximate the cylindrical base.

17. The sorbent article of claim 12 further comprising a cylindrical base and at least one bore extending into the cylindrical base.

18. The sorbent article of claim 17 wherein the at least one bore is at least one through bore, the at least one through bore comprises a cross sectional shape selected from the group consisting of: a circle, a polygon, and a star, and the at least one bore tapers from a first end to a second end.

19. The sorbent article of claim 12 wherein the uptake rate ratio is greater than or equal to 3.0.

20. The sorbent article of claim 12 wherein the uptake rate ratio is greater than or equal to 4.0.

21. The sorbent article of claim 12 wherein the uptake rate ratio is greater than or equal to 5.0.

22. The sorbent article of claim 12 further comprising:
a cylindrical base comprising an exposed surface area having only flat surfaces, convex surfaces or combinations thereof;
a plurality of substantially planar surfaces extending generally perpendicularly from the exposed surface the cylindrical base, each of the plurality of substantially planar surfaces being generally parallel to each adjacent substantially planar surface;
each of the plurality of substantially planar surfaces comprises at least one protrusion extending generally towards an adjacent substantially planar surface; and,
a sidewall extending generally perpendicularly from a circumferential edge of the cylindrical base.

23. A computer hard drive comprising:
a sorbent article comprising a base, wherein the sorbent article is formed from a resin bonded sorbent composition and having a first volume of the resin bonded sorbent composition used to form the sorbent article and a first surface area equal to a first total area of exposed surfaces of the first volume;
a capacity ratio of the first volume to a second volume greater than or equal to 0.5; and,
an uptake rate ratio greater than or equal to 2.0, wherein the uptake rate ratio is calculated according to the equation:
$$α = \frac{{SA}_{1} / {V}_{1}}{{SA}_{2} / {V}_{2}} ,$$
wherein:
α is the uptake rate ratio
SA₁ is the first surface area
V₁ is the first volume
SA₂ is a second surface area
V₂ is the second volume,
wherein a comparative sorbent article comprises the second volume and the second surface area, the second volume comprising only flat surfaces, convex surfaces or combinations thereof and being a minimum volume necessary to inscribe the first volume and the second surface area equal to a second total area of exposed surfaces of the second volume.

24. The computer hard drive of claim 23 wherein the base comprises an exposed surface area having only flat surfaces, convex surfaces or combinations thereof and the sorbent article further comprises at least one of: a protrusion extending from the exposed surface area of the base; and/or, a partial bore extending into the exposed surface area of the base.

25. The computer hard drive of claim 23 wherein the sorbent article further comprises at least one of: a protrusion extending from the base; a through bore within the base; and/or, a partial bore extending into the base.

26. The computer hard drive of claim 23 further comprising:
a cylindrical base comprising an exposed surface area having only flat surfaces, convex surfaces or combinations thereof;
a plurality of substantially planar surfaces extending generally perpendicularly from the exposed surface the cylindrical base, each of the plurality of substantially planar surfaces being generally parallel to each adjacent substantially planar surface;
each of the plurality of substantially planar surfaces comprises at least one protrusion extending generally towards an adjacent substantially planar surface; and,
a sidewall extending generally perpendicularly from a circumferential edge of the cylindrical base.

27. A sorbent article formed from a resin bonded sorbent composition comprising:
a cylindrical base comprising an exposed surface area having only flat surfaces, convex surfaces or combinations thereof;
a plurality of substantially planar surfaces extending generally perpendicularly from the exposed surface the cylindrical base, each of the plurality of substantially planar surfaces being generally parallel to each adjacent substantially planar surface;
each of the plurality of substantially planar surfaces comprises at least one protrusion extending generally towards an adjacent substantially planar surface; and,
a sidewall extending generally perpendicularly from a circumferential edge of the cylindrical base.
